(19) United States
(12) Patent Application Publication
(10) Pub. No.: US 2025/0023229 A1
(43) Pub. Date: Jan. 16, 2025

(54) ANTENNA DEVICE

(71) Applicant: Wistron NeWeb Corp., Hsinchu (TW)

(72) Inventors: Chih-Feng YANG, Hsinchu (TW); Che-Min LIN, Hsinchu (TW); Yu-Ju CHEN, Hsinchu (TW)

(21) Appl. No.: 18/745,259

(22) Filed: Jun. 17, 2024

(30) Foreign Application Priority Data
Jul. 14, 2023 (TW) 112126381

(51) Int. Cl. H01Q 1/32

(52) U.S. Cl. CPC H01Q 1/32

(57) ABSTRACT

An antenna device including an antenna structure, a base, an elastic bracket, a restriction unit, and a fastener is provided. The base is connected to the antenna structure. The base includes a plurality of grooves. The elastic bracket includes a plurality of elastic legs. Each of the elastic legs includes a free end. The free end is guided by the corresponding groove. The elastic legs abut the restriction unit. The fastener affix the restriction unit to the base. At least a portion of the elastic bracket is disposed between the restriction unit and the base.

### CROSS REFERENCE TO RELATED APPLICATIONS

This application claims the benefit of priority to Taiwan Patent Application No. 112126381, filed on Jul. 14, 2023. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### BACKGROUND OF THE INVENTION

### Field of the Invention

The embodiments of the present disclosure relate to an antenna device, in particular to an antenna device with a mounting and fixing function.

### Description of the Related Art

With the increasing maturity of technologies like autonomous driving, vehicles gradually need to be equipped with antenna devices to meet the demand for wireless communication. In the current practice, antenna devices are installed on the vehicle shell and secured with nuts. However, since the affixing method of the nut must increase the size and the number of parts of the antenna device, there is room for further improvement in terms of appearance and cost. In addition, in the conventional fastening approach, after the antenna device is mounted on the vehicle shell, the antenna device must be affixed with a nut, leading to user inconvenience during the operation.

### BRIEF SUMMARY OF THE INVENTION

The embodiments of the present disclosure intend to solve the problems of the prior art and provide an antenna device including an antenna structure, a base, an elastic bracket, a restriction unit, and a fastener. The base is connected to the antenna structure. The base includes a plurality of grooves. The elastic bracket includes a plurality of elastic legs. Each of the elastic legs includes a free end. The free end is guided by the corresponding groove. The elastic legs respectively abut the restriction unit. The fastener affixes the restriction unit to the base, and at least a portion of the elastic bracket is disposed between the restriction unit and the base.

In one embodiment, the elastic bracket includes a bracket body. Each of the elastic legs includes a first segment, a second segment, an abut segment, and a guide segment. The first segment is connected to the bracket body. The second segment is connected to the first segment. The abut segment is connected to the second segment. The guide segment is connected to the abut segment. The free end is at the guide segment.

In one embodiment, the bracket body is clamped between the restriction unit and the base.

In one embodiment, the first segment is extended from the bracket body toward a direction away from the base. The second segment is extended from the first segment toward a direction in proximity to the base.

In one embodiment, the restriction unit includes a plurality of restriction parts. The restriction parts respectively correspond to the first segments. Each of the first segments abuts the corresponding restriction unit.

In one embodiment, the first segment abuts the corresponding restriction part in a manner of line contact or surface contact.

In one embodiment, each of the restriction parts includes an inclined surface. The fastener is connected to the base along a direction. An included angle is between the restriction part and the direction, and the included angle is greater than 0 degree and smaller than 90 degrees.

In one embodiment, the antenna device is adapted to be mounted on a vehicle shell. The vehicle shell has a vehicle shell opening and an abut region. The abut region surrounds the vehicle shell opening. When the antenna device is mounted on the vehicle shell, the abut segments are adapted to abut the abut region.

In one embodiment, the abut segment is at least partially parallel to the abut region.

In one embodiment, the guide segment is located between the inner periphery of the vehicle shell opening and the base.

In another embodiment, the present disclosure provides an antenna device including an antenna structure, a base, an elastic bracket, a restriction unit, and a fastener. The base is connected to the antenna structure. The elastic bracket includes a bracket body and a plurality of elastic legs. One end of each of the elastic legs is connected to the bracket body. The elastic legs respectively abut the restriction unit. The fastener penetrates through the restriction unit and the bracket body and affixes to the base. The bracket body is clamped between the restriction unit and the base.

In one embodiment, the antenna device further includes a wire, wherein the base includes a base opening, and the wire passes through the base opening.

In one embodiment, the antenna device further includes a waterproof gasket. The waterproof gasket surrounds the base and abuts an outer surface of the vehicle shell.

In the embodiments of the present disclosure, a fastener is adopted to lock the antenna device. In one embodiment, the fastener may be a bolt. Compared with conventional technology, the antenna devices in the embodiments of the present disclosure have smaller size and fewer components, thus saving costs and enhancing the competitiveness of the product. In addition, the fastener can be partially affixed to the base in advance, so after the antenna device is placed on the vehicle shell, the fastener can be directly locked to complete the fixing, which is convenient for the user to operate.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present invention can be more fully understood by reading the subsequent detailed description and examples with references made to the accompanying drawings, wherein:

FIG. 1 is an assembly diagram of an antenna device according to an embodiment of the present disclosure;

FIG. 2 is an exploded view of the antenna device according to the embodiment of the present disclosure;

FIG. 3A is an assembly diagram of the main structure of the antenna device according to the embodiment of the present disclosure;

FIG. 3B is an exploded view of the main structure of the antenna device according to the embodiment of the present disclosure;

FIG. 4 is a cross-sectional view of the main structure of the antenna device according to the embodiment of the present disclosure;

FIG. 5 is a wire according to the embodiment of the present disclosure;

FIGS. 6A, 6B, 6C, and 6D show mounting processes of the antenna device according to the embodiment of the present disclosure; and

FIG. 7 is a cross-sectional view of the antenna device according to another embodiment of the present disclosure.

### DETAILED DESCRIPTION OF THE INVENTION

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

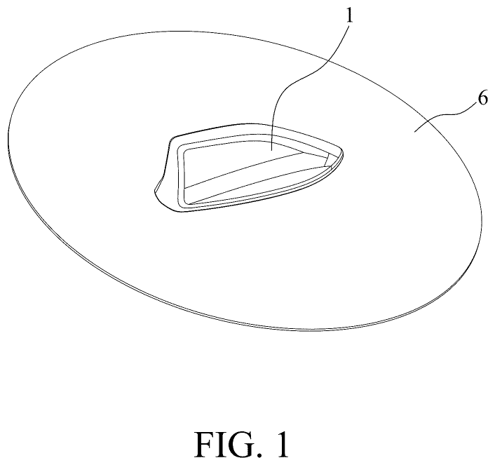

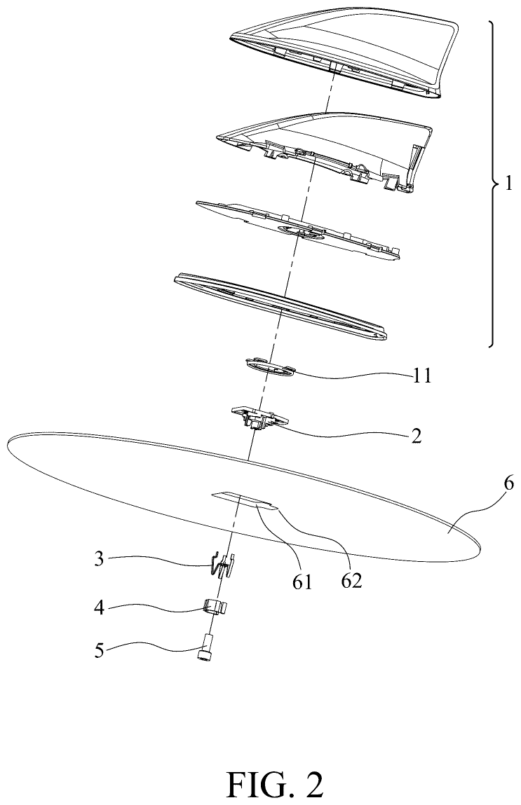

FIG. 1 is an assembly diagram of an antenna device according to an embodiment of the present disclosure. FIG. 2 is an exploded view of the antenna device according to the embodiment of the present disclosure. Refers to FIGS. 1 and 2 together. An antenna device in the embodiment of the present disclosure includes an antenna structure 1, a base 2, an elastic bracket 3, a restriction unit 4, and a fastener 5. The base 2 is connected to the antenna structure 1. In one embodiment, the antenna device further includes a waterproof gasket 11. The antenna device is adapted to be mounted on a vehicle shell 6. The vehicle shell 6 has a vehicle shell opening 61 and an abut region 62.

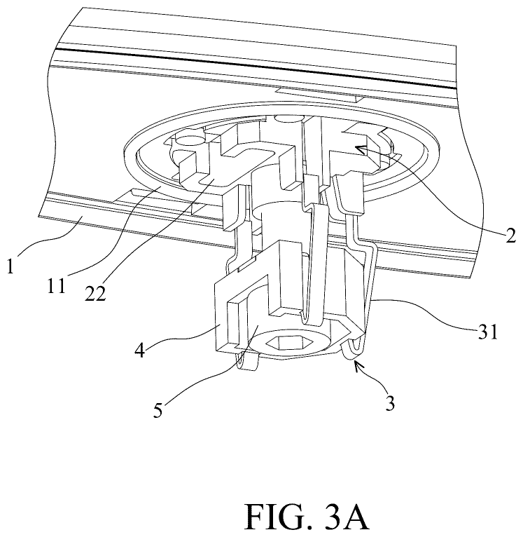

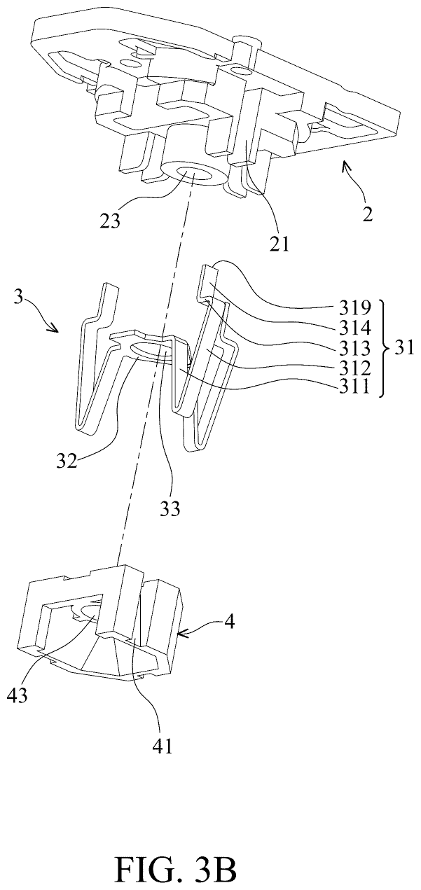

FIG. 3A is an assembly diagram of the main structure of the antenna device according to the embodiment of the present disclosure. FIG. 3B is an exploded view of the main structure of the antenna device according to the embodiment of the present disclosure. Refers to FIGS. 3A and 3B together. The base 2 includes a plurality of grooves 21. The elastic bracket 3 includes a plurality of elastic legs 31 in which each of the elastic legs 31 includes a free end 319. The free end 319 is guided by the corresponding groove 21. The elastic legs 31 respectively abut the restriction unit 4. The fastener 5 affixes the restriction unit 4 to the base 2. At least a portion of the elastic bracket 3 is disposed between the restriction unit 4 and the base 2.

Refers to FIGS. 3A and 3B. In one embodiment, the base 2 includes a base through hole 23. The elastic bracket 3 includes a bracket opening 33. The restriction unit 4 includes a restriction unit through hole 43. Threads are formed in the base through hole 23 and the restriction unit through hole 43, so as to be screwed together with the fastener 5.

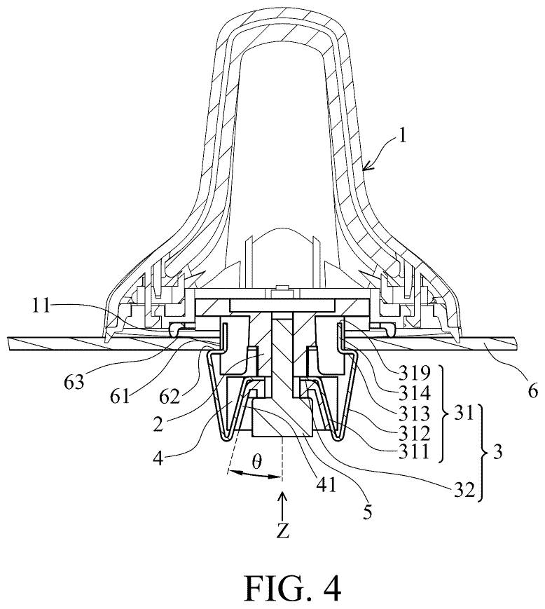

FIG. 4 is a cross-sectional view of the main structure of the antenna device according to the embodiment of the present disclosure. Refers to FIGS. 3A, 3B, and 4 together. In one embodiment, the elastic bracket 3 includes a bracket body 32. Each of the elastic legs 31 includes a first segment 311, a second segment 312, an abut segment 313, and a guide segment 314. The first segment 311 is connected to the bracket body 32. The second segment 312 is connected to the first segment 311. The abut segment 313 is connected to the second segment 312. The guide segment 314 is connected to the abut segment 313. The free end 319 is at the guide segment 314.

In one embodiment, the elastic bracket 3 is a metal bracket. The above disclosure does not limit the present invention. For example, the elastic bracket 3 can also be made of plastic or other materials.

Refers to FIGS. 3A, 3B, and 4 together. In one embodiment, the bracket body 32 is clamped between the restriction unit 4 and the base 2.

Refers to FIGS. 3A, 3B, and 4 together. In one embodiment, the first segment 311 and the second segment 312 forms a V-shape structure. The first segment 311 is extended from the bracket body 32 toward a direction away from the base 2. The second segment 312 is extended from the first segment 311 toward a direction in proximity to the base 2.

Refers to FIGS. 3A, 3B, and 4 together. In one embodiment, the restriction unit 4 includes a plurality of restriction parts 41. The restriction parts 41 respectively correspond to the first segments 311. Each of the first segments 311 abuts the corresponding restriction unit 41.

Refers to FIGS. 3A, 3B, and 4 together. In one embodiment, the first segment 311 abuts the corresponding restriction part 41 in a manner of line contact or surface contact.

Refers to FIGS. 3A, 3B, and 4 together. In one embodiment, each of the restriction parts 41 is inclined surface. The fastener 5 affixes (is screwed to) the base 2 along the Z direction. An included angle θ is between the restriction part 41 and the Z direction. The included angle θ is greater than 0 degree and smaller than 90 degrees.

Refers to FIGS. 2 and 4 together. In one embodiment, the antenna device is adapted to be mounted on a vehicle shell 6. The vehicle shell 6 has a vehicle shell opening 61 and an abut region 62. The abut region 62 surrounds the vehicle shell opening 61. When the antenna device is mounted on the vehicle shell 6, the abut segments 313 are adapted to abut the abut region 62, so as to prevent the antenna device from detaching from the vehicle shell 6.

Refers to FIGS. 2 and 4 together. In one embodiment, the abut segment 313 is at least partially parallel to the abut region 62.

Refers to FIGS. 3B and 4 together. In one embodiment, the guide segment 314 is located between the inner periphery of the vehicle shell opening 61 and the base 2 (within the corresponding groove 21). Specifically, after the antenna device is mounted on the vehicle shell 6, the guide segment 314 is located between the inner periphery of the vehicle shell opening 61 and the base 2. In one embodiment, the grooves 21 can limit the guide segments 314 to increase the supporting strength of the elastic legs 31.

Refers to FIGS. 2, 3A, and 4. In one embodiment, the antenna device further includes a waterproof gasket 11, wherein the waterproof gasket 11 surrounds the base 2. The waterproof gasket 11 abuts an outer surface 63 of the vehicle shell 6.

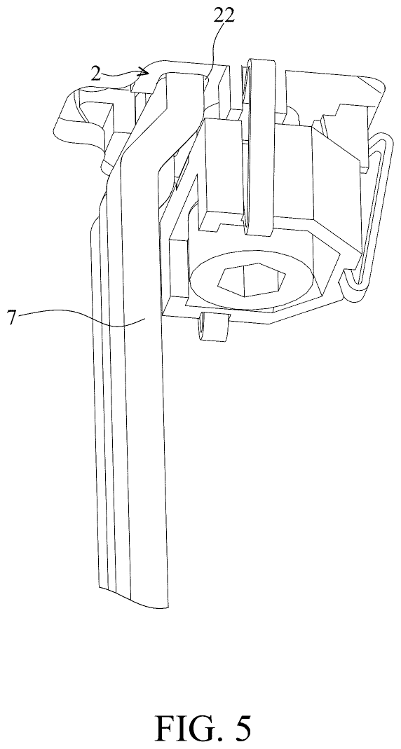

FIG. 5 is a wire according to the embodiment of the present disclosure. Refers to FIGS. 3A and 5 together. In one embodiment, the antenna device further includes a wire 7. The base 2 includes a base opening 22, and the wire passes through the base opening 22.

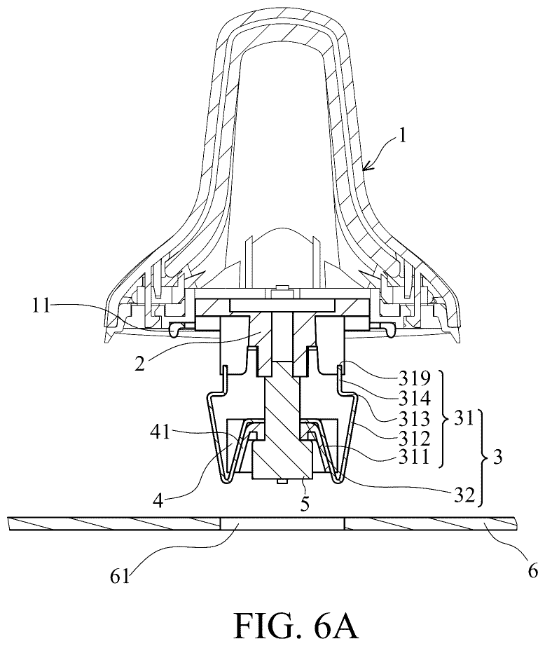

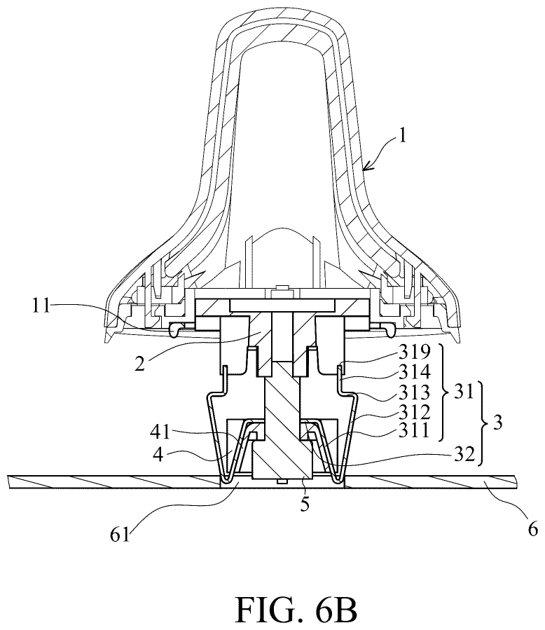

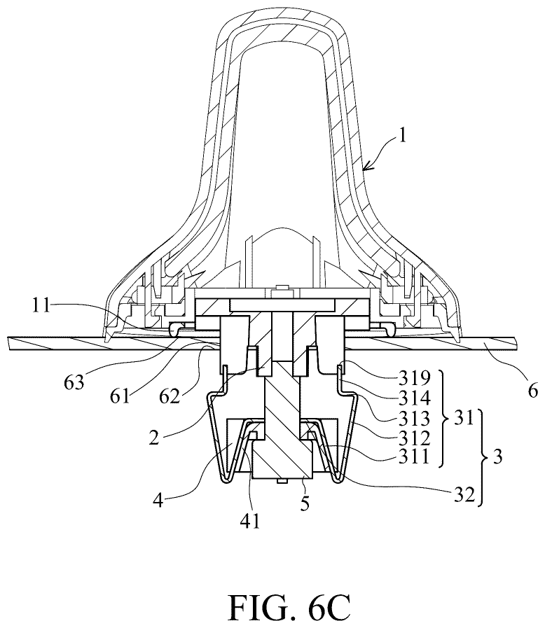

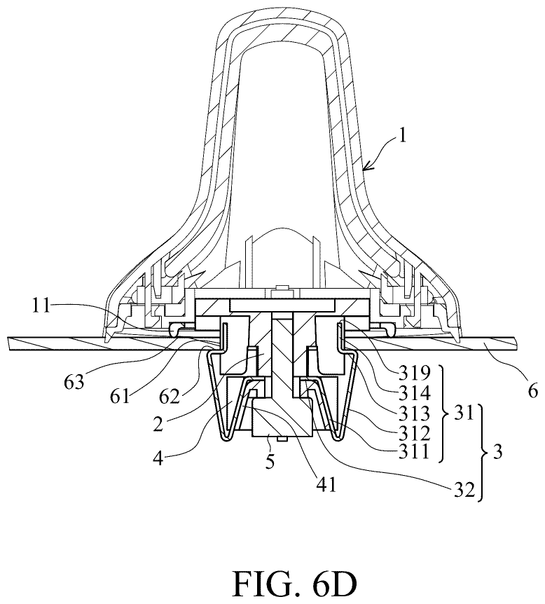

FIGS. 6A, 6B, 6C, and 6D show the mounting processes of the antenna device according to the embodiment of the present disclosure. Refers to FIGS. 3B, 6A, 6B, 6C, and 6D together. Firstly, the fastener 5 passes through the restriction unit through hole of the restriction unit 4 and the bracket opening of the elastic bracket 3 in advance. The fastener 5 is also connected (or screwed) to the base 2 (FIG. 6A). Next, the antenna device is connected downward to the vehicle shell 6. The elastic legs 31 of the elastic bracket 3 is forced to be compressed and passes through the vehicle shell opening 61 (FIGS. 6A and 6B). Finally, the fastener 5 is locked to be securely connected with the base 2. The elastic bracket 3 moves upward with the restriction unit 4, so that the abut segments 313 abut the vehicle shell 6. During this process, the elastic legs 31 do not perform any outward expansion movement.

Refers to FIG. 6D. After the fastener 5 is locked and securely connected to the base 2, the restriction parts 41 provide support for the elastic legs 31. In other words, when an upward pulling force is applied to the antenna structure 1, the first segments 311 are supported by the restriction parts 41 to prevent deformation of the elastic legs 31, which could otherwise result in pulling up the antenna structure 1.

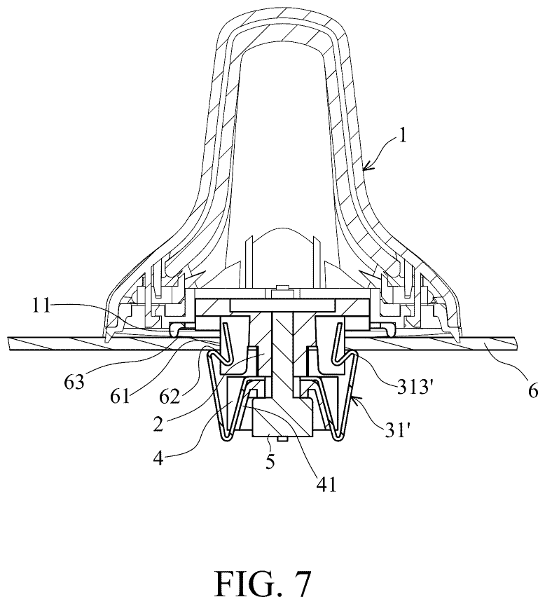

FIG. 7 is a cross-sectional view of the antenna device according to another embodiment of the present disclosure. Refers to FIG. 7, in the present embodiment, the abut segment 313′ of each of the elastic legs 31′ is in a bent shape, and the abut segment 313′ abuts the vehicle shell 6, so as to prevent detachment of the antenna device from the vehicle shell 6.

In the embodiments of the present disclosure, the antenna device is fixed by a fastener. In one embodiment, the fastener may be a bolt. Compared with conventional technology, the antenna devices in the embodiments of the present disclosure have smaller size and fewer components, thus saving costs and enhancing the competitiveness of the product. In addition, the fastener can be partially affixed to the base in advance, in this way, after the antenna device is placed on the vehicle shell, the fastener can be directly locked to complete the fixing, which is convenient for the user to operate.

The foregoing description of the disclosure has been presented only for the purposes of illustration and description option of the exemplary embodiments and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An antenna device, comprising:
an antenna structure;
a base connected to the antenna structure, wherein the base includes a plurality of grooves;
an elastic bracket comprising a plurality of elastic legs, wherein each of the elastic legs comprises a free end, and the free end is guided by the corresponding groove;
a restriction unit, wherein the elastic legs respectively abut the restriction unit; and
a fastener, wherein the fastener affixes the restriction unit to the base, and at least a portion of the elastic bracket is disposed between the restriction unit and the base.

2. The antenna device according to claim 1, wherein the elastic bracket comprises a bracket body, each of the elastic legs comprises a first segment, a second segment, an abut segment, and a guide segment, the first segment is connected to the bracket body, the second segment is connected to the first segment, the abut segment is connected to the second segment, the guide segment is connected to the abut segment, the free end is at the guide segment.

3. The antenna device according to claim 2, wherein the bracket body is clamped between the restriction unit and the base.

4. The antenna device according to claim 2, wherein the first segment is extended from the bracket body toward a direction away from the base, and the second segment is extended from the first segment toward a direction in proximity to the base.

5. The antenna device according to claim 2, wherein the restriction unit comprises a plurality of restriction parts, the restriction parts respectively correspond to the first segments, each of the first segments abuts the corresponding restriction unit.

6. The antenna device according to claim 5, wherein the first segment abuts the corresponding restriction part in a manner of line contact or surface contact.

7. The antenna device according to claim 6, wherein each of the restriction parts comprises an inclined surface, the fastener affixes the base along a direction, an included angle is between the restriction part and the direction, and the included angle is greater than 0 degree and smaller than 90 degrees.

8. The antenna device according to claim 6, wherein antenna device is adapted to be mounted on a vehicle shell, the vehicle shell has a vehicle shell opening and an abut region, the abut region surrounds the vehicle shell opening, and when the antenna device is mounted on the vehicle shell, the abut segments are adapted to abut the abut region.

9. The antenna device according to claim 8, wherein the abut segment is at least partially parallel to the abut region.

10. The antenna device according to claim 8, wherein the guide segment is located between the inner periphery of the vehicle shell opening and the base.

11. An antenna device, comprising:
an antenna structure;
a base connected to the antenna structure;
an elastic bracket comprising a bracket body and a plurality of elastic legs, one end of each of the elastic legs is connected to the bracket body;
a restriction unit, wherein the elastic legs respectively abut the restriction unit; and
a fastener, wherein the fastener penetrates through the restriction unit and the bracket body and affixes the base, the bracket body is clamped between the restriction unit and the base.

12. The antenna device according to claim 11, wherein each of the elastic legs includes a first segment, a second segment, and an abut segment, the first segment is connected to the bracket body, the second segment is connected to the first segment, the abut segment is connected to the second segment.

13. The antenna device according to claim 12, wherein the first segment is extended from the bracket body toward a direction away from the base, and the second segment is extended from the first segment toward a direction in proximity to the base.

14. The antenna device according to claim 12, wherein the restriction unit comprises a plurality of restriction parts, the restriction parts respectively correspond to the first segments, each of the first segments abuts the corresponding restriction unit.

15. The antenna device according to claim 14, wherein the first segment abuts the corresponding restriction part in a manner of line contact or surface contact.

16. The antenna device according to claim 15, wherein each of the restriction parts comprises an inclined surface, the fastener affixes the base along a direction, an included angle is between the restriction part and the direction, and the included angle is greater than 0 degree and smaller than 90 degrees.

17. The antenna device according to claim 12, wherein the base comprises a plurality of grooves, each of the elastic legs further comprises a guide segment, the guide segment is connected to the abut segment, and each of the guide segments is guided by the corresponding groove.

18. The antenna device according to claim 11, further comprising a wire, wherein the base includes a base opening, and the wire passes through the base opening.

19. The antenna device according to claim 12, wherein the antenna device is adapted to be mounted on a vehicle shell, the vehicle shell has a vehicle shell opening and an abut region, the abut region surrounds the vehicle shell opening, and when the antenna device is mounted on the vehicle shell, the abut segments are adapted to abut the abut region.

20. The antenna device according to claim 19, further comprising a waterproof gasket, wherein the waterproof gasket surrounds the base and abuts an outer surface of the vehicle shell.
